(19) United States
(12) Patent Application Publication
(10) Pub. No.: US 2006/0228455 A1
(43) Pub. Date: Oct. 12, 2006

(54) Procedure for obtaining foodstuffs based on nopal and/or other vegetables

(76) Inventors: Jose Adalberto Garza-Lopez, Garza Garcia (MX); Sergio Roman Othon Serna-Saldivar, Monterrey (MX); Norberto Elizondo-Garza, Apodaca (MX)

Correspondence Address: Breiner & Breiner, L.L.C., P.O. Box 19290, Alexandria, VA, 22320-0290, US

(21) Appl. No.: 11/099,668

(22) Filed: Apr. 6, 2005

(51) Int. Cl. A21D 10/00

(52) U.S. Cl. 426/549

(57) ABSTRACT

The present invention relates to a procedure for mixing dehydated nopal flour and/or other vegetable flours with cereal flours, refined and/or whole flours from corn, wheat, oats and other leguminous and/or oleaginous flours and obtaining peculiar foodstuffs due to color and nutritional profile high in fiber and other nutrients. Humankind's diet is generally low in dietary fiber, vegetables in general and nopal in particular, are one of the richest natural sources of dietary fiber, nopal's virtue is its very high content of insoluble fiber and soluble fiber. Similarly, using this current procedure it is possible to substitute water by liquefied nopal and/or other liquefied vegetables in the elaboration of products like tortillas, bread, cookies, pastas, wheat flour tortillas, etc., that may or may not be a step in the previous procedure. In addition, substitution of typical breading and batter formulations by nopal flour and/or other vegetables and/or products elaborated by the previous procedures in the process of breading meat, fish, seafood, and vegetables and other. On the other hand, using this process it is possible to elaborate low calorie foodstuffs, based on cut dehydrated nopal, seasoned or not.

### BACKGROUND OF THE INVENTION

We have known for many years that humankind needs to consume dietary fiber when feeding. Due to its different affinity for water, dietery fiber is divided into soluble and insoluble. Insoluble fiber is mainly made up of cellulose and lignin, while hydrosoluble fiber is made up of B-glucans, pectin and other types of mucilage or gum that bond many times their weight in water. Inadequate consumption of insoluble dietary fiber may cause severe digestive disorders, and that includes colon cancer, constipation, diverticulosis, colitis and associated problems. On the other hand, soluble dietary fiber has been associated with a decrease in diabetes, hypercholesterolemia, hyperlipidemia, and cardiovascular disease symptoms. For the purpose of this invention, nopal is the pad or cladodes of the edible plants of the Cactacea family, Subfamily Opuntiodeae, all species of cacti plants known in Mexico as nopal or nopales.

Nopal is one of the few foodstuffs containing high quantities of both types of dietary fiber and consequently it is an excellent product to help prevent all previously described disorders. Its soluble dietary fiber content is outstanding, which has positive health effects on diabetics, and people with high cholesterol, and those prone to cardiovascular diseases. These chronic degenerative diseases are responsible for most deaths occurring today in the modern World.

Vegetables and whole grains are a natural source of dietary fiber. The nopal “produce” variety is a product used since ancient times; its consumption as a dehydrated product, although known for many years, has not had a considerable development nor has it been used in composite food product manufacturing. In truth, its main use has been as a nutrition supplement in capsules.

On the other hand, the Occidental world diet is high in consumption of refined flours, mainly from corn, wheat and other. These cereals are prepared as bread, corn chips, tortillas, carckers, low dietary fiber products, etc.

The nopal's pad dehydration process has been known for many years. It may be sun dried or dehydrated by artificial processing. Grinding the dehydrated nopal produces a fine powder of flour. The means or methods to obtain flour, be it by sun drying or by artificial means, and the method for milling, are out of the scope of the present invention, nopal flour is considered a raw material.

The dietary fiber content of the resulting mix improves when mixing nopal flour with cereal flours, and when mixed in the appropriate amounts novelty foodstuffs will be obtained, as they will not be “the same” as those currently consumed, they will have the typical greenish color, depending on the amount added, and will be nutritionally very different.

The idea of mixing cereal flours with nopal flour, or nopal juice, even if simple, has not been used to manufacture cookies, tostadas, fritters, tortilla chips, wheat tortillas, bread and many other products.

The scope of the present invention encompasses many more lines of products, as well as mixing liquefied nopal with other juices; for example orange, however; substitution of required water has not been sought when manufacturing the aforementioned products, with liquefied nopal. This is achieved as follows: the nopal is cleaned off spines, cut in chunks and processed in a blender or hammer mill, until it is much liquefied or in paste form. Before and/or after cleaning spines form the nopal, disinfect in a water-based solution containing 200-300 ppm chlorine and/or other disinfectant (See annex A, examples 1,3,4 and 5). This invention aims to substitute water with liquefied nopal in the manufacture of several products and/or adding dehydrated nopal flour and/or other dehydrated vegetables, replacing a portion of legumes and/or oilseed and/or cereal flours or their secondary products or their total substitution of said flours with nopal flour.

By using the present invention, the nopal is used as base vegetable, when considering its diverse nutritional properties, which does not limit the invention to this single vegetable.

### DESCRIPTION OF THE INVENTION

The present invention refers to the elaboration of diverse nutritional products that use nopal flour and/or liquefied nopal mixed with cereal flour, grains, legumes and/or oil seeds, either refined and/or whole; in order to obtain diverse foodstuffs with a different color and nutritional profile to that obtained if nopal and/or liquefied nopal was not used.

In the same manner, the present invention refers to the elaboration of a snack based on cut nopal processed by using a potato chip cutter, and dehydrated.

### BEST METHOD FOR THE PREFERRED EMBODIMENT

The manner in which foodstuffs will be prepared using nopal flour or liquified nopal will depend on the product sought for manufacture.

In general, the following products may be manufactured with nopal flour and/or liquefied nopal, mixed with other cereal flours:

1. Fermented bread products with a different color and nutritional profile from those currently obtained.

2. Leavened bakery products, fermented with industrial yeast or baking powders, or chemical leavening agents, with a different color and nutritional profile from those currently obtained.

3. Long and/or short pasta, with a different color and nutritional profile from those currently obtained.

4. Nixtamalized, fried and/or non fried bakery and/or snack products with a different color and nutritional profile from those currently obtained.

5. Refined and/or whole-wheat flour tortillas, which may or may not contain chemical agents with a different color and nutritional content from regular flour tortillas.

6. Mixes or compound flours from flour products, from cereals, legumes and other grains; refined and/or whole with nopal flour or flour form other vegetables elaborated to be sold, and that adding one or more missing ingredients, may be used to elaborate any of the aforementioned products.

7. Products for breading meats, vegetables and other foodstuffs, either using nopal flour and/or other vegetable flours, mixed with commercial breading/batter formulas and/or bakery products enriched with nopal flour as those aforementioned as an integral portion of the formula. Additionally, liquefied nopal may be used alone or combined with batters as a binder.

Similar to the aforementioned new applications, by means of this invention a new way to consume dehydrated nopal may be found:

8. To elaborate a snack based on dehydrated nopal, spiced or not, obtaining a novelty product, said snack having very different and superior nutritional properties compared snacks currently consumed.

### EXAMPLE 1

To elaborate fermented bakery products with a different color and nutritional profile.

Mixes containing 10%, 20% and 30% nopal flour with moisture content of 8% and particle size less than U.S. 60 with commercial bakery wheat flour preferably classified as bakers or hard. Yeast leavened bread was elaborated using the AACC (American Association of Cereal Chemists) official micro baking procedure (2002). Basic formulation is shown in Table 1.

TABLE 1
Formulations used for pan bread production with
nopal flour using direct micro baking method.

| | | | | |
|---|---|---|---|---|
| Nopal flour (gr.) | 0 | 10 | 20 | 30 |
| Wheat flour (gr.) | 100 | 90 | 80 | 70 |
| Salt (gr.) | 1.5 | 1.5 | 1.5 | 1.5 |
| Sugar(gr.) | 6 | 6 | 6 | 6 |
| Dry yeast (gr.) | 2 | 2 | 2 | 2 |
| Vegetable shortening | 3.5 | 3.5 | 3.5 | 3.5 |
| Vital Gluten (gr.) | 0 | 0 | 0 | 1.5 |
| Water (gr.) | 63 | 62 | 62.5 | 62.5 |
| Nopal flour (gr.) | 0 | 10 | 20 | 30 |
| Malt (gr.) | 0.1 | 0.1 | 0.1 | 0.1 |

Water was used in this instance; however, it may be substituted by liquefied nopal. The ingredients where weighed, mixed and kneaded in a laboratory micro-mixer until the desired dough texture was achieved (fully developed gluten). The resulting dough was divided in two equal portions of the same weight in order to obtain data from loaves produced with 100 gr. of flour; the dough was allowed to ferment for an hour in a fermentation cabinet regulated or calibrated to 29° C. and 85.95% relative humidity. Portions were sheeted using a roller sheeter calibrated to 3/16 inch to eliminate carbon dioxide generated during fermentation and to create multiple micro spaces within the dough that later become the typical internal crumb texture. The dough was placed again in the fermentation cabinet for 25 minutes and was sheeted the same way; finally, the dough was placed for 13 more minutes in the fermentation cabinet in preparation for its final sheeting and molding. The fermented dough was sheeted in this instance thru a pair of rollers with 5/16 inch clearance and the resulting strip was manually rolled to make a cylinder, which was placed in pregreased baking pans. The pans, with their dough cylinders were placed in the fermentation cabinet for 37 minutes; once final fermentation ended, the height was measured and they were immediately placed in a pre-heated oven at. 210° C., baking time was exactly 20 minutes; the resulting loaves were immediately removed from the pan and characterized, the height on the midway of the loaves, loaf weight, and loaf volume determined by displacement of rapeseed, apparent density (weight/volume) and subjectively the internal texture of the breadcrumb.

TABLE 2
Effect from adding different concentrations of nopal flour
to the estimated bread properties by direct bakery process.

| | | | | Height | | | |
|---|---|---|---|---|---|---|---|
| | | Dough | Loaf | differ- | | | |
| | | height | height | ence | Weight | Volume | Density |
| Treatment | | (cm) | (cm) | (cm) | (gr.) | (cm3) | (gr./cm. 3) |
| Control | A | 6.9 | 9.1 | 2.2 | 153.2 | 655 | 0.233 |
| | B | 6.9 | 8.7 | 1.9 | 152.3 | 650 | 0.234 |
| 10% | A | 7.2 | 7.3 | 0.1 | 154.1 | 553 | 0.278 |
| Nopal | B | 7.2 | 7.7 | 0.5 | 154.2 | 595 | 0.259 |
| 20% | A | 6 | 6.2 | 0.2 | 161.1 | <400 | >0.4 |
| Nopal | B | 6 | 6.1 | 0.1 | 161.2 | <400 | >0.4 |
| 30% | A | 5 | 5.3 | 0.3 | 163.3 | <400 | >0.4 |
| Nopal | B | 4.6 | 5.0 | 0.4 | 163.1 | <400 | >0.4 |

Results clearly indicate that it was feasible to produce pan bread using different amounts of nopal flour. However, adding nopal significantly decreased volume and height of the loaf consequently increasing apparent density (Table 2); Addition of nopal flour produced breads with a greenish color and a pleasant flavor; addition of 30% nopal flour increased total dietary fiber from 2% to 8.09% and decreased caloric density from 274 kcal/100 g to 240 kcal/100 g. Consumption of 100 gr. of bread containing 30% nopal flour provided approximately 27% of the daily dietary fiber requirement considering 30 g/day as requirement (Table 3).

This example clearly demonstrates that it is feasible to use nopal flour in partial substitution of wheat flour and that similar results may be expected from other yeast leavened bakery products like French bread, baguettes, pita bread, or inclusive saltine crackers or wafers. Adding nopal did not affect yeast activity. To counteract the diluting impact of nopal in gluten, and negative on bread volume, formulations may be enriched with Vital Gluten.

TABLE 3
Nutritional content effect from adding different concentrations of nopal flour
on bread and its relation to nutritional requirements on a 2000 kcal/day diet

| | | | | | | % of the | % of the | % of the | % of the |
|---|---|---|---|---|---|---|---|---|---|
| | | | | | | requirement | requirement | requirement | requirement |
| | | | | | | with an | with an | with an | with an |
| | | Bread | Bread | Bread | | intake of an | intake of | intake of | intake of |
| | 100% | w/10% | w/20% | w/30% | Daily | intake of | 100 g bread | 100 g bread | 100 g bread |
| | bread | nopal | nopal | nopal | require- | 100 g bread | w/10 nopal | w/20 nopal | w/30 nopal |
| | 100 g | flour | flour | flour | ment | consumption | flour | flour | flour |
| Moisture y (%) | 34.8 | 35.2 | 34 | 35 | — | — | — | — | — |
| Energy (Kcal) | 274 | 262 | 255 | 240 | 2000 | 13.7 | 13.1 | 12.75 | 12 |
| Dietary fiber (gr.) | 2 | 4.02 | 6.15 | 8.09 | 30 | 6.6 | 13.4 | 20.5 | 26.96 |
| Calcium (mg) | 32 | 195.6 | 364 | 522 | 1000 | 3.2 | 19.56 | 38.4 | 52.252.2 |
| Potassium (mg) | 111 | 361.8 | 620 | 561 | 2000 | 5.5 | 18.09 | 31 | 43.05 |

### EXAMPLE 2

In order to manufacture chemically leavened bakery products with a different color and nutritional profile to the one currently held on these types of products.

In order to demostrate this, oat cookies were elaborated with nopal. The following ingredients were mixed in the quantities specified below:

180 gr. of Wheat flour

190 gr. of Oats

185 gr. of Sugar

120 gr. eggs (two hen eggs)

180 gr. of butter

4 gr. Double Acting baking powder

3 gr. of salt

90 gr. of nopal flour

All ingredients were perfectly mixed with a blender. To add other/stronger flavors, additional cinnamon, raisins, coconut, pecan, almonds, etc., according to personnel taste; once all ingredients had been mixed, the dough was sheeted and cut; the resulting portions were placed on a previously greased baking sheet, which in turn was placed in an oven at 170° C. during 15 minutes. It was feasible to make oat cookies enriched with nopal, using the regular preparation procedure for this type of cookies, adding nopal flour had significant effect on the cookie color and flavor, when adding this amount of nopal flour the content of dietary fiber was increased 5% approximately.

TABLE 4
Effect of adding 9.4% nopal flour vs. not adding in cookies of

| | | | | % of the Req. with | % of the Req. with |
|---|---|---|---|---|---|
| | 100 g of oat | 100 g of oats | | an intake of 100 g | an intake of 100 g |
| | cookies | w/nopal | Daily requirement | oat cookies | oat cookies w/nopal |
| Moisture (%) | 17.1 | 16.9 | — | — | — |
| Calories (kcal) | 468 | 2000 | 23.4 | 21.6 | |
| Dietary fiber (g) | 2.5 | 5.03 | 30 | 8.3 | 16.7 |
| Calcium (mg) | 79.4 | 306 | 1000 | 7.94 | 30.6 |
| Potassium (mg) | −140 | 495 | 2000 | 7 | 24.75 |

Addition of nopal flour decreased caloric density of the cookies and significantly increased the content of dietary fiber, calcium and potassium. (Table 4). These cookies may help maintain gastrointestinal health, and provide over 24% of daily requirements of calcium and potassium, these minerals are generally deficient in the human diet, calcium helps to prevent osteoporosis and potassium prevents hypertension.

By this example, it is clearly demonstrated that it is feasible to manufacture bakery products leavened with chemical or baking powder agents as muffins, hot cakes, biscuits, etc., by partial substitution of wheat flour by nopal flour.

### EXAMPLE 3

For fabrication of long and/or short pasta, with a different color and-nutritional profile from those currently available in these type of products.

Weigh the following:

+200 grams of Semolina (88.2%)

+27 grams of nopal flour (11.8%)

+90 grams of Water

The ingredients were perfectly mixed in a laboratory pasta mixer-extruder, it was left mixing for 6 minutes and proceeded to extrude thru a macaroni die; half the macaroni were dried to produce dehydrated pasta, and the other half was cooked in excess water.

Macaroni was cooked in boiling water for 4 minutes; their color, texture, and flavor were pleasant and characteristic, the difference was in color, as nopal flour made the pasta acquire a greenish tint. The nutritional profile of the macaroni with nopal: is different from the commercial, dietary fiber increased from 2.7% to approximately 5.85%. Consumption of 100 g of dehydrated pasta with nopal provides 19.8% of the requirement of dietary fiber (Table 5).

Weight 170 g of Semolina, 57 g of nopal flour (73% or/and 25% respectively) and were both mixed with 90 g of water in a commercial pasta mixer-extruder. It was mixed for 6 minutes until the proper dough for extrusion was formed. After that extrusion began, macaroni sixe was uniformly maintained to prevent differences in the drying and cooking times. Macaroni were cut to average 4 cm in lenght; the resulting macaroni were cooked for 4 minutes in boiling water, its color, flavor, and texture were characteristic. However, macaroni tended to break apart easily, and therefore to loose their form or structure, in both cases water may be substituted for liquefied nopal.

Dietary fiber content in the first case increased to almost 6% of the weight of the macaroni; in the second case, the increase wass over 10% (Table 5).

Calcium supply when consuming 100 g of macaroni with 11.8% nopal flour is slightly higher than 50% of the daily requirement for this nutrient.

With this example, it is demonstrated that it is feasible to produce fresh and dehydrated pasta enriched with nopal flour; therefore, this example is not limiting and covers all types of pasta (composite pastas, microwave fast cooking, instant soups, etc.)

*TABLE 5
Effect from adding two levels of nopal flour in the nutrient content of 100 g macaroni,
and its relation to daily requirements of several nutrients on a 2000 kcal/day diet

| | | 100 g | 100 g | | | % of the Req. | % of the Req. |
|---|---|---|---|---|---|---|---|
| | | regular | regular | | % of the Req. | Supplied when | Supplied when |
| | | macaroni | macaroni | | Supplied when | consuming 100 | consuming 100 |
| | 100 g | with | with 25% | | consuming 100 | g of macaroni | g of macaroni |
| | regular | 11.8% of | of nopal | Require- | g of regular | with 11.8% of | with 25% of |
| | macaroni | nopal flour | flour | ment | macaroni | nopal flour | nopal flour |
| Moisture (%) | 12 | 12.1 | 11 | — | — | — | — |
| Energy (kcal) | 364 | 353 | 341 | 2000 | 18.2 | 17.65 | 17.05 |
| Dietary fiber (gr) | 2.7 | 5.85 | 10.7 | 30 | 9 | 19.5 | 35.5 |
| Calcium (mg) | 252 | 525 | 830 | 1000 | 25.2 | 52.5 | 83 |
| Potassium (mg) | 107 | 508 | 1085 | 2000 | 5.35 | 28.4 | 54 |

### EXAMPLE 4

For fabrication of nixtamalized products, fried and non-fried, with a different color and nutritional profile as to what is available in these types of products.

A typical way, but not unique, of preparing these types of products is to weigh:
850 g of commercial nixtamalized corn flour
Weigh 150 g of nopal flour (15%)
1000 ml of warm water (38° C.) was added and knead until obtaining a consistent dough (approximately 5 minutes), water may be substituted with nopal juice and/or liquefied nopal, or mix 150 g of nopal flour with 1.85 kg nixtamalized dough obtained using the traditional or industrial process.
A tortilla machine was used to make several tortilla disk that were baked for approximately 1 minute at 280° C. in a typical three-tier gas fired oven.
The resulting tortilla may be packaged to supply table tortillas or may be used as raw material for making tostadas and/or fritters; for the first step it is recommended to fine-mill the nixtamal or use fine nixtamalized flour, for appetizer fabrication it is recommended to use coarse dough or flour.
Nopal flour and/or any other vegetable content may vary from 1% up to 99.5% depending on the concentration and product being sought.
To obtain additional data on nopal flour impact on nixtamalized products, tortillas containing a higher concentration of nopal flour (25%) were elaborated.
Weigh 750 g of commercial nixtamalized corn flour.
Weigh 250 g of nopal flour 25%.
1000 ml of warm water (38° C.) was added and kenad until obtaining consistent dough (approximately 5 minutes).
The tortillas were elaborated using the same tortilla machine used previously.

In both cases, nopal-containing tortillas were the characteristic greenish color, higher nopal content produces tortillas with a darker color.

To convert the tortillas into tortilla chips and/or tostadas, they were deep-fat fried in edible oil for 1 minute at 175°, if desired, salt and/or seasonings may be added right after frying.

*TABLE 6
Effect from adding two different levels of nopal flour in the elaboration of tortillas and fritters

| | | 100 g of | 100 g of | | | % of the Req. | % of the Req. |
|---|---|---|---|---|---|---|---|
| | | regular | regular | | | Supplied when | Supplied when |
| | | tortilla | tortilla | | % of the Req. | consuming 100 | consuming 100 |
| | | with 15% | with 25% | | Supplied when | g of tortilla with | g of tortilla with |
| | 100 g of regular | of nopal | of nopal | Require- | consuming 100 | 15% of nopal | 25% of nopal |
| | tortilla | flour | flour | ment | g of tortilla | flour | flour |
| Moisture (%) | 46 | 47.5 | 48.1 | — | — | — | — |
| Energy (kcal) | 222 | 185 | 181 | 2000 | 11.1 | 9.25 | 9.05 |
| Dietary fiber (g) | 4.99 | 6.8 | 8.16 | 30 | 16.6 | 22.6 | 27.2 |
| Calcium (mg) | 168 | 342 | 344 | 1000 | 16.8 | 34.2 | 34.4 |
| Potassium (mg) | 148 | 439 | 643 | 2000 | 7.4 | 22 | 32 |

Addition of nopal flour significantly decreased the product's caloric density and increased dietary levels of dietary fiber, Calcium & Potassium. These may be channeled to the diet product market that has higher nutritional attributes than the commercial product. This example clearly demonstrates that nopal may be a partial substitute for nixtamalized corn, dough or nixtamalized flour, this example demonstrates that it is feasible to produce other nixtamalized products like tostadas, fritos, tamales, atoles (gruel), etc.

### EXAMPLE 5

To elaborate wheat flour tortillas, refined and/or whole, that may or may not contain chemical leavening agents with a color and nutritional content different from those found currently in flour tortillas; a typical way, but not unique, of preparing these types of products is:

Weighed the following ingredients:
All purpose Wheat flour 180 gr.
Nopal flour 20 gr.
Vegetable shortening or animal fat 20 gr.
Baking powder 3 gr.
Salt 3 gr.
Emulsifier 0.4 gr.
Powdered milk 1 gr.
Lecithin 0.5 gr.

100 ml of warm water (35-40° C.) was added and all listed ingredients were kneaded until obtaining a well developed gluten and smooth dough consistency; liquefied nopal may be used instead of water (see examples 1,3,4,5 in Annex).
“We proceeded to cut the dough in 35 gr. portions that were immediately hand rolled forming balls and left to rest at ambient temp during 10 minutes, a controlled environment chamber may be used regulated to 28-30° C. and 85% relative humidity; the dough balls were hot pressed forming disks, which were baked during 45 seconds in a three tier gas fired oven regulated to 220° C.; The resulting tortillas were cooled and packed in polyethylene bags.
The resulting tortillas may be consumed as such, or, as part of another product.
To obtain sweet flour tortillas using the previous mix, sugar and other types of sweeteners may be added.
Content of nopal flour or any other vegetable may be between 1% and 99%.

In the previous example, dietary fiber content was increased to over 4.5% when consuming 100 g of this product, representing 15.7% of the daily requirement, Calcium and Potassium were significantly increased also, (Table 7).

TABLE 7
Effect from adding 10% nopal flour to flour tortilla elaboration.

| | | | | | % of the req. |
|---|---|---|---|---|---|
| | | | | % of the req. | supplied when |
| | | Flour tortilla | | supplied when | consuming 100 g of |
| | Regular flour | w/10% of | Require- | consuming 100 g of | regular flour tortilla |
| | tortilla 100 g | nopal flour | ment | regular flour tortilla | w/10% of nopal flour |
| Moisture (%) | 38% | 39% | — | — | — |
| Energy (kcal) | 313 | 299 | 2000 | 15.65 | 14.95 |
| Dietary fiber (g) | 3.4 | 4.7 | 30 | 11.3 | 15.7 |
| Calcium (mg) | 15 | 184 | 1000 | 1.5 | 18.4 |
| Potassium (mg) | 163 | 386 | 2000 | 8.15 | 19.3 |

With this example, it is demonstrated that it is also feasible to produce refined and/or whole-wheat flour tortillas “enriched with nopal flour”, as well as fried products like salad baskets and chimichangas (deep fried burritos).

Annex To Examples 1,2,3,4, & 5

If water is substituted by liquefied nopal, in examples 1 to 5, it is recommended to exercise good hygiene practices. A typical way of elaboration is presented next.

1. Select nopal pads in perfect shape and of good quality.

2. Disinfect with chlorine water (200 ppm chlorine), if chlorine water is not available, use any other desinfectant, bactericide, viricide or similar in the water, at the recommended dosage. Pads may be left in the specified solution during the required time (from 10 minutes to 1 hour) or enough amount of the solution may be flushed over the pads.

3. Clean spines off nopal, may be done manually or mechanically, or both ways.

4. Once pads are free of spines, it is convenient to disinfect again obtaining a cleaner product.

5. Once pads have been cleaned of spines and disinfected, proceed to liquefy in a blender until they are completely liquefied. The resulting liquid my be strained of filtered or used directly as a water substitute.

Step 3, cleaning of spines may be eliminated if you are sure the blender will destroy spines and/or liquefied nopal will be filtered or strained.

For the purposes of this invention, nopal that has been disinfected and cleaned of spines is considered as raw material. The ways and procedures used to accomplish the aforementioned, are outside the scope of the present invention. In the same manner, the juice and/or other liquefied vegetables are considered raw material, regardless of the procedure performed to obtain them.

Similarly, nopal flour and/or from other vegetables is considered raw material, regardless of the process used to elaborate it.

In addition to the foregoing, in all examples described in the present invention, the following may be included as ingredients; flavorings, gums, colorants, preservatives, etc.

### EXAMPLE 6

To elaborate flour product mixes from cereals, leguminous and grains in general, refined and/or whole that are elaborated to be sold, and that adding one or more missing ingredients, they may be used to elaborate any of the aforementioned products.

This example refers to elaboration of products that are mixtures of vegetable and/or nopal powders with cereal and/or legumes and/or oilseed flours. These mixtures may be marketed so that once the missing ingredient or ingredients are added; novelty products may be elaborated that are equivalent to the current ones, but with a different color and nutritional profile.

To exemplify:

a. If it is required to elaborate any nixtamalized product that contains nopal flour and/or other vegetable flours, a mixture will be prepared containing nixtamalized corn flour and nopal and/or vegetable flour, and packed for use; afterwards. Whoever has acquired this mix, at home or his/her business, will add water and/or liquefied nopal to elaborate tortillas, tostadas, etc. The invention consists of using nopal flour and/or other vegetable flous in the nixtamalized flour mix.

b. If required to elaborate wheat flour tortillas with nopal and/or any other vegetable flour, wheat flour is mixed with nopal flour and/or other vegetable(s) & other ingredients such as baking powder, powdered milk, emulsifiers, shortening, etc. being able to pack this mix.

Afterwards, whoever has acquired this mix, will add water and/or liquefied nopal, and any other ingredients like flavorings, preservatives, etc., will knead and proceed to elaborate flour tortillas with nopal flour and/or other vegetable flours. The present invention consists of the addition of nopal flour and/or other vegetable flours in the flour mixture; in addition, substitution, if desired, of water by liquefied nopal.

c. If required to fabricate leavened bakery products, with chemical leavening agents or baking powders, all dry-powdered ingredients will be mixed with the refined and/or whole cereal flours, sugar, cinnamon, seasonings, etc., with nopal flour and/or other vegetable flours, for later packin and/or marketing, shortening and/or similar products may also be added, to this mix water and/or liquefied nopal will be added, lard, margarine, butter, etc., if the necessary amounts was not previously added, in the proper amounts to fabricate the desired products. The present invention consists of the inclusion of nopal flour and/or other vegetables flours and/or later addition of liquefied nopal together with/or instead of water.

d. If required to fabricate long and/or short pasta, semolina is mixed with nopal flour and/or other vegetables flours or condiments in the desired amounts. This mixture may be packaged; water and/or liquefied nopal would be added later for dough texture and extrusion and cutting to desired size and drying during the necessary time; the present invention consists of the inclusion of nopal flour and/or other vegetable flours or condiments in the solids mixture and/or substitution of water by liquefied nopal.

e. To elaborate fermented bakery products with a different color & nutritional profile. For elaboration of these products, all ingredients should be mixed based on powders or flours, as: nopal flour and/or from other vegetables, wheat flour, salt, sugar, dry yeast, malt, Vital Gluten, and if required some other ingredient, condiments and/or preservatives, including lard, are mixed and packaged for later use. To this mixture water and/or liquefied nopal and lard will be added later, if required, in the amounts required for the elaboration of the desired products proceeding to sheeting and baking. The present invention consists of the inclusion of the mixture of nopal flour and/or of other vegetables with the other solid ingredients and/or water substitution with liquefied nopal.

### EXAMPLE 7

To elaborate a product for “breading” with nopal flour, and/or a mixture of nopal flour with spices, and/or ground toasted bread, and/or saltine cookies, and/or ground Habanera cookies, and/or wheat flour, and/or raw or nixtamalized corn flour, either elaborated with refined and/or whole flours. In addition to using liquefied nopal alone or combined with wheat flours and/or other cereals supplemented with battered eggs, milk gums, emulsifiers and modified starch as adherent agent, similarly ground toasted bread may be used, that has been elaborated in the manner described in example 1, that is to say, in both cases with nopal flour and/or liquefied nopal, and/or other vegetable flours and/or juice or liquefied vegetables.

Fried chicken was elaborated using a commercial breading formula from which 30% of its weight was substituted by nopal flour; Chicken thighs were first submerged in a batter elaborated from wheat flour, beaten eggs, milk, and water and later breading by simple contact of the portion “wetted” in the batter with the breading mix. Products were fried at 175° C. during 4 minutes a commercial fryer containing canola vegetable oil. The breading that had 30% nopal flour increased aherence and changed color towards a darker greenish shade that became darker after the frying process, flavor changed slightly also but was pleasant for consumers.

In the same way, the formulation may be entirely substituted with nopal flour obtaining a “breading” with higher adhesion power, darker and pleasant flavor; this product with 100% nopal flour breading and/or other vegetable flours, may be used by consumers that desire to increase their dietary fiber, Calcium & Potassium intake.

TABLE 8
Effect from adding two different levels of nopal flour in two commercial breading products, and a ground dry bread containing 30% of nopal
flour, and 100% nopal flour product, and their relation with the nutritional requirements for several nutrients on a 2000 kcal/day diet.

| | | | 100 g | | 100 g | | | | | 100 g | | 100 g | |
|---|---|---|---|---|---|---|---|---|---|---|---|---|---|
| | | | bread | 100 g | tradi- | | | | | bread | 100 g | tradi- | |
| | 100 g | | contain- | granulated | tional | | | 100 g | | contain- | granulated | tional | |
| | commer- | 100 g | ing 30% | corn | ground | | | commer- | 100 g | ing 30% | corn | ground | |
| | cial | tradi- | dry | flakes | bread | | | cial | tradi- | dry | flakes | bread | |
| | granulated | tional | nopal | w/20% | w/20% | 100 g | | granulated | tional | nopal | w/20% | w/20% | 100 g |
| | corn | ground | (sample | nopal | nopal | nopal | Require- | corn | ground | (sample | nopal | nopal | nopal |
| | flakes | bread | 1) | flour | flour | flour | ment | flakes | bread | 1) | flour | flour | flour |
| Moisture | 10 | 11 | 12 | 9.6 | 10.4 | 8 | — | — | — | — | — | — | — |
| (%) | | | | | | | | | | | | | |
| Energy | 370 | 306 | 325 | 350.8 | 300 | 274 | 2000 | 18.5 | 15.3 | 16.25 | 17.5 | 15 | 13.7 |
| (kcal) | | | | | | | | | | | | | |
| Dietary | 2.5 | 0.6 | 10.95 | 6.8 | 7.36 | 34.4 | 30 | 8.3 | 2 | 36.5 | 29.3 | 24.5 | 114 |
| fiber (g) | | | | | | | | | | | | | |
| Calcium (mg) | 213 | 200 | 707 | 683 | 673 | 2505 | 1000 | 213 | 20 | 70.7 | 68.3 | 67.3 | 256.5 |
| Potassiu | 105 | 112 | 1165 | 888 | 894 | 4020 | 2000 | 5 | 5.6 | 58.25 | 44.4 | 44.7 | 201 |
| (mg) | | | | | | | | | | | | | |

Similar to previous examples, adding nopal lowered caloric density and significantly increased dietary fiber, Calcium & Potassium levels; these results demostrate that it is feasible to substitute different levels on the formulations for shakes and/or breading, and to manufacture meats, seafood, and produce with a different nutritional profile to breaded products containing regular formulations. A 100% substitution of bread by nopal flour is worth mentioning. Dietary fiber, Calcium & Potassium supply to daily requirement is over 100%. In addition, caloric content decreased remarkably.

### EXAMPLE 8

Elaborate a snack based on dehydrated nopal, maybe spiced or not. Obtaining a totally innovative product, with superior nutritional value in comparison to those currently consumed. Commercial French fries are regularly cut using a produce cutter, obtaining very thin slices and later fried and lastly salted and/or seasoned.

This invention consists in processing nopal in a similar way to commercial potato offerings, that is to say, sut in a produce processor in very thin slices, to be consumed as a snack, being elaborated using dehydrated nopal, preferably using the following procedure:

1) Select whole, good quality nopal pads,

2) Disinfect with chlorinated water (200 ppm of chlorine) or using another bactericide at the proper concentration.

3) Clean spines off nopal. This may be done by hand, mechanically, or both.

4) Cut the nopal pads. The desired and searched form is that of a thin nopal sliver of variable thickness of less than 1 mm, or up to 3 mm or more. The searched form is similar to that of fried potato snacks currently consumed. This operation may be performed with raw or cooked nopal in boiling water during 5 minutes or longer.

5) As nopal's external cuticle is the thinnest part on this cut, the inside becomes exposed, which is the one containing the moist and sticky mucilage, thus its possible to add a solid seasoning like ground hot chilly peppers, ground garlic, ground onion, etc. Similarly, a liquid seasoning may be added like salt dissolved in water, citric acid dissolved in water, the amounts of each of these, to provide the taste of preference of the target market.

6) With or without seasonings, cut nopal is dehydrated in trays thru a dehydrator tunnel, or using any dehydration method, for example lyophilization, microwave oven drying, vacuum drying and/or a combination of these.

7) In order to preserve the most color and flavor, temperature should never exceed 80 degrees centigrade. It is recommended to use the highest possible air speed, to shorten dehydration time, which may vary from 1 to 16 hours, being air speed and its temperature the most important variables, the foregoing in case dehydration takes place in a dehydration tunnel or similar. To improve color, flavor, texture and rehydration ability of dehydrated nopal and/or other dehydrated vegetables, it is recommended to use newer sophisticated dehydration methods, as lyophilization, conventional vacuum drying, and microwave drying with and without vacuum.

8) Nopal may be bagged directly when dry, it, this operation may be performed by hand, mechanically or electronically. To prevent texture loss, it is recommendable to pack the hygroscopic product in aluminized sealed bags, or highdensity polypropylene, or any material that may offer a good barrier against air humidity.

9) If no seasoning was added in step 4, and this is desired, it is recommended to apply a water solution with gum Arabic (@10%), or water/maltodextrins (@10%), or any other adherent in order to wet the nopal chips; when moist, seasoning may be applied in a way to improve adhesion to the finished product. Drying may be achieved using the same tunnel dehydrator or any of the previously described methods.

10 Once dehydration is finished, bagging will proceed, according to number 8, previously described.

Dietary fiber content of this product is approximately 34.4%.

TABLE 9
Typical commercial fried potatoes assay
comparison with a low calorie snack.

| | | | | % of daily | % of daily |
|---|---|---|---|---|---|
| | | 100 gr. | | requirement | requirement |
| | 100 g | dehy- | | with 100 | with 100 |
| | fried | drated | Require- | g fried | gr. dry |
| | potatoes | nopal | ment | potatoes | nopal |
| Mois- | 1.4 | 8 | — | — | — |
| ture (%) | | | | | |
| Energy | 558 | 274 | 2000 | 27.9 | 13.7 |
| (kcal) | | | | | |
| Dietary | 3.6 | 34.4 | 30 | 12 | 114.7 |
| fiber (g) | | | | | |
| Calcium | 24 | 2555 | 1000 | 2.4 | 256.5 |
| (mg) | | | | | |
| Potassi- | 1008 | 4020 | 2000 | 50.4 | 201 |
| um (mg) | | | | | |

Difference between these two products is significantly notorious, given that calorie content of fried potatoes is over twice as much. Content of dietary fiber, Calcium & Potassium is significantly extremely different. With this we prove, that this invention substitutes, in a very advantageous manner conventional fried potatoes that may, in most cases, over 30% oil.

The previous description is offered as an example to demonstrate the preferred method of procedure preparation, however, it is not our intention to limit the scope of this invention to what has been described, but to reserve any procedure that following the principles herewith, produces the same industrial results.

That we claim is:

1. A procedure for obtaining nopal based foodstuffs and/or other vegetables characterized by a different color and/or nutritional profile starting by a) mixing nopal flour and/or other vegetable flours with other cereals, and/or legumes, and/or oilseed flours in any of its forms or their secondary products, and/or tubers, tubers flours or their secondary products in the fabrication of products such as long and/or short pasta, wheat flour tortillas, any product fabricated with nixtamalized corn flour and/or fresh nixtamalized (masa), bakery products that have been leavened with chemical leavening agents, breakfast cereals and/or snacks elaborated by thermoplastic extrusion method or related, compound mixes, or compound flours (mixes) for fabrication of any or the aforementioned products; mixing nopal flour and/or other vegetables with cereal flours and/or legumes and/or oilseeds and/or tubers and/or the secondary products of the above mentioned products, substituting water (if included in the process) by liquefied nopal and/or other liquefied vegetbles in the elaboration of any product mentioned in paragraph a; substituting water, partially or totally, if included in the process, by liquefied nopal and/or other liquefied vegetables, in the elaboration of any product mentioned; by partial or total substitution of grain flours, tubers, or secondary products from these, by nopal flour and/or other vegetable flours, in products used for “breading” meats, fish and seafood, vegetables and/or any other product; cutting dehydrated nopal in a special manner, and seasoning or not, to obtain a low calorie snack.

2. A procedure for obtaining foodstuffs based on nopal and/or other vegetables, characterized by mixing nopal flour and/or liquefied nopal with other cereal, legumes and/or oleaginous flours, or its secondary products, bakery fermented products may be elaborated having a color and nutritional profile different containing nopal flour and/or liquefied nopal and/or other vegetable flours and/or juice or other liquefied vegetables; among these products several can be mentioned like leavened bread as French loaves, pizza base, croissants, Arab bread and including saltine and cracker type cookies; within this category we also claim production of premixes enriched with nopal flour and/or other vegetable flours and/or liquefied nopal and/or other liquiefied vegetables.

3. A procedure for obtaining foodstuffs based on nopal and/or other vegetables, as described in claim 1, characterized by the viability to fabricate and elaborate bakery products that have been leavened with chemical leavening agents of baking powders containing nopal flour and/or liquefied nopal and/or other vegetable flours and/or juice from other liquified vegetables; among these products are products leavened with chemical leavening agents like sweet and salted cookies, cakes, hotcakes, muffins, biscuits, corn bread and related products.

4. A procedure for obtaining foodstuffs based on nopal and/or other vegetables, as described in claim 1, characterized by the viability to fabricate and elaborate nixtamalized products; fried and/or without frying, with a different color and nutritional profile that contains nopal flour and/or liquefied nopal and/or other vegetable flours and/or juice or other liquefied vegetables; among these products are table tortillas, fritos, tamales, tostadas and related products elaborated with nixtamal and/or nixtamalized flours, These products may also contain legume flour tubers, oilseed flours, or their secondary products.

5. A procedure for obtaining foodstuffs based on nopal and/or other vegetables; as described in claim 1; characterized by the viability to fabricate and elaborate long and/or short pasta (soups) natural or fast cooking with a different color and nutritional profile; containing nopal flour and/or liquefied nopal and/or other vegetable flours and/or juice u other liquefied vegetables. These products may also contain legume flour tubers, oilseed flour, or their secondary products.

6. A procedure for obtaining foodstuffs based on nopal and/or other vegetables; as described in claim 1; caracterized by the viability to fabricate and elaborate refined and/or whole wheat flour tortillas, that may or may not contain chemical agents, that contain nopal flour and/or liquefied nopal and/or other vegetable flours and/or juice or other liquefied vegetables, with a different color and nutritional profile to that of current tortillas, as these typically contain only wheat flour. But may also contain other legume, oilseed, and or any their secondary products, that may partially or totally substitute wheat flour.

7. A procedure for obtaining foodstuffs based on nopal and/or other vegetables; as described in claim 1; characterized by the viability to fabricate and elaborate compund flour mixes from refined and/or whole cereal flours, oleaginous and/or legumes, and or tubers, and or any of their secondary products, with nopal flour and/or other vegetable flours; and adding one or more missing ingredients; may be used to elaborate any of the products described in claim 1.

8. A procedure for obtaining foodstuffs based on nopal and/or other vegetables, as described in claim 1, characterized by the viability to fabricate and elaborate formulations for “breading”, where nopal flour and/or other vegetable flours substitutes partially or totally the formulation ingredients; where this product may be a mixture of cereal flour like wheat, raw corn or nixtamalized corn and/or regular ground toasted bread and/or bread and/or saltine cookies and/or granulated and/or ground corn flakes, and/or potato or other tuber flours, with different concentrations of nopal for breading and batter formulations, with toasted or dehydrated bakery products, with nopal flour and/or other vegetable flours, containing or not other ingredients or condiments, or, not a mix, but a substitute for current commercial breading by nopal flour in proportions from 1% up to 100%.

9. A procedure for obtaining foodstuffs based on nopal and/or other vegetables, as described in claim 1, consisting in cutting dehydrated nopal, as chips, in very thin slices; if it was seasoned before dehydration, or it is seasoned after, or if it is not seasoned, a low calorie snack will be obtained, it being a substitute for fritters, and commercial French fries, with a very high content of soluble and insoluble dietary fiber.

10. A procedure for obtaining foodstuffs based on nopal and/or other vegetables, as described in claim 1, characterized by nopal flour and/or of other vegetables and/or juice of nopal and/or liquefied nopal that may also partially or totally substitute the fiber sources used in the production of cereals and foodstuffs elaborated in general by means of thermoplastic extrusion or related processes; nopal flour may partially substitute refined flour or grits from cereals used as raw material in the elaboration of these products.
